(19) United States
(12) Patent Application Publication
(10) Pub. No.: US 2008/0025483 A1
(43) Pub. Date: Jan. 31, 2008

(54) Communication system and voice message processing method for use in the system

(75) Inventors: Takanori Kaji, Tokyo (JP); Shuichi Sato, Sagamihara-shi (JP); Kazuhiro Sumi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/878,994

(22) Filed: Jul. 30, 2007

(30) Foreign Application Priority Data
Jul. 31, 2006 (JP) 2006-208791

(51) Int. Cl. H04M 1/64

(52) U.S. Cl. 379/88.22

(57) ABSTRACT

According to one embodiment, a communication system includes a plurality of voice-mail apparatuses which record a voice message transmitted from a telephone terminal in an arbitrary mail box among a plurality of mail boxes, and reproduces the voice message recorded in the arbitrary mail box in response to a reproduction instruction, a plurality of memory apparatuses which include a plurality of mail boxes connected to the plurality of voice-mail apparatuses via a data transmission path and shared among the plurality of voice-mail apparatuses, convert the voice message incoming from the data transmission path into a file format possible to be processed by the plurality of voice-mail apparatuses to record it in the arbitrary mail box, and store control programs and control data, and a controller which selects at least one memory apparatus, and executes processing of the voice message for the selected memory apparatus based on prescribed conditions.

### CROSS-REFERENCE TO RELATED APPLICATIONS

This application is based upon and claims the benefit of priority from Japanese Patent Application No. 2006-208791, filed Jul. 31, 2006, the entire contents of which are incorporated herein by reference.

### BACKGROUND

1. Field

One embodiment of the present invention relates to a communication system which records a voice message from a caller in an arbitrary mail box and reproduces the voice message therefrom, and a voice message processing method for use in the system.

2. Description of the Related Art

Up to now, a telephone exchange apparatus such as a private branch exchange (PBX) and a key telephone apparatus have been widely used in, e.g., an office building, or business establishment. A voice-mail apparatus is connected to the telephone exchange apparatus. The telephone exchange apparatus has a function to transfer a call incoming from, e.g., an office line to an extension telephone to the voice-mail apparatus when the extension telephone accommodated in the telephone exchange apparatus does not respond because it is in use or the user thereof is in leaving therefrom.

Meanwhile, after starting the use of the telephone exchange apparatus, in response to an increase in user, or to a change in business content, the number of the voice-mail apparatuses in the telephone exchange apparatus or the number of the telephone exchange apparatuses has to become large sometimes. Conventionally, a system, which distributes to dispose a plurality of voice processing units and storage processing units on a computer network, such as a local area network (LAN), and may flexibly correspond to an addition or an change of the voice and storage processing units, has been proposed (e.g., JP-A H9-298556).

In the meantime, it fully supposed even for the system given above to pose troubles with hard disks, power sources, etc., of the plurality of voice processing units and storage processing units. Here, when a voice processing unit becomes wrong, the storage processing unit corresponding to the voice processing unit is not used to be left for a long while.

A method for connecting an external storage apparatus to the voice-mail apparatus is a possible approach. However, in the method, the external memory apparatuses which are connected to each of the voice-mail apparatuses have to be updated its programs or prompt data whenever the voice-mail apparatuses are increased in number and changed in system. Thus, it takes much time and work to maintain the external memory apparatuses.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating a configuration of a communication system regarding the first embodiment of the invention;

FIG. 2 is an exemplary block diagram illustrating an internal configuration of a voice-mail apparatus depicted in FIG. 1;

FIG. 3 is an exemplary sequence view illustrating operations for connecting voice-mail apparatuses to network storages in the first embodiment of FIG. 1;

FIG. 4 is an exemplary view illustrating an example of storage contents of databases in the voice-mail apparatuses in the first embodiment;

FIG. 5 is an exemplary sequence view illustrating operations for specifying network storages to be used for each voice-mail apparatus as the second embodiment of the invention;

FIG. 6 is an exemplary view illustrating an example of storage contents of database in the voice-mail apparatuses in the second embodiment;

FIG. 7 is an exemplary sequence view illustrating operations for connecting the voice-mail apparatuses to the network storages as the third embodiment of the invention;

FIG. 8 is an exemplary sequence view illustrating operations for synchronizing data among the network storages as the fourth embodiment of the invention; and

FIG. 9 is an exemplary sequence view illustrating operations in the case in which troubles occur in all network storages and in which the network storages are fixed from the troubles as the fifth embodiment of the invention.

### DETAILED DESCRIPTION

Various embodiments according to the invention will be described hereinafter with reference to the accompanying drawings. In general, according to one embodiment of the invention, a communication system, comprising: a plurality of voice-mail apparatuses which record a voice message transmitted from a telephone terminal in an arbitrary mail box among a plurality of mail boxes, and reproduces the voice message recorded in the arbitrary mail box in response to a reproduction instruction; a plurality of memory apparatuses which include a plurality of mail boxes connected to the plurality of voice-mail apparatuses via a data transmission path and shared among the plurality of voice-mail apparatuses, convert the voice message incoming from the data transmission path into a file format possible to be processed by the plurality of voice-mail apparatuses to record it in the arbitrary mail box, and store control programs and control data necessary to reproduce the voice message recorded in the arbitrary mail box in response to the reproduction instruction; and a controller which selects at least one of memory apparatuses among from the plurality of the memory apparatuses, and executes processing of the voice message for the selected memory apparatus based on prescribed conditions, when processing requests of the voice message transmitted from a telephone terminal are made.

### FIRST EMBODIMENT

According to an embodiment, FIG. 1 is a block diagram depicting a configuration of a communication system regarding the first embodiment of the invention, and symbols BT1-BTm indicate main apparatuses, respectively.

Each main apparatus BT1-BTm is provided with voice-mail apparatuses 151-15m, respectively (FIG. 1 only shows a voice-mail apparatus 151).

A main apparatus BT1 includes an analog trunk interface unit 11, a digital extension telephone interface unit 12, a time switch 13, a central control unit 14, and a voice-mail apparatus 151. Among of them, the trunk interface unit 11, the extension telephone interface unit 12, the control unit 14, and the voice-mail apparatus 151 are connected to one another via a control bus 16. The trunk interface unit 11, the extension telephone interface unit 12, the time switch 13, and the voice-mail apparatus 151 are connected to one another via a voice bus 17.

The trunk interface unit 11 is connected to a public network PNW to perform establishment processing, etc., of calls to and from the public network PNW.

The extension interface unit 12 accommodates a plurality of extension terminals DKT1-DKTi (i is natural number). For example, digital key telephones are used as the extension terminals DKT1-DKTi. The extension interface unit 12 conducts sending and receiving processing and transfer processing of digital signals, etc., for the extension terminals DKT1-DKTi.

The time switch 13 carries out exchange connections among the trunk interface unit 11, the extension interface unit 12, and the voice-mail apparatus 151 in accordance with an instruction from the control unit 14.

The control unit 14 has usual control function, such as a function, of sending processing resulting form call requests from each extension terminal DKT1-DKTi, of a usual receiving processing resulting from an outside line call termination from the public network PNW, and of transfer processing among extension terminals DKT1-DKTi. The control unit 14 further has an incoming call response control function in the use of the voice-mail apparatus 151. If the extension terminal DKT1 does not respond for the incoming call, the incoming call response control function calls out an incoming call to the voice-mail apparatus 151 to connect between the voice-mail apparatus 151 and an outgoing origin, thereby, it controls so that the voice-mail apparatus 151 sends prescribed guidance data to the outgoing origin.

The voice-mail apparatus 151 has mail boxes corresponding to each extension terminal DKT1-DKTi, and stores a voice message from a caller in an arbitrary mail box.

Each main apparatus BT2-BTm also has the same function as that of the main apparatus BT1 mentioned above.

By the way, a plurality of network storages NS1-NSp (p is natural number) are connected to a plurality of voice-mail apparatuses 151-15m of the first embodiment via a LAN 2. The respective network storages NS1-NSp include CPUs and hard disks, and have storage media M1-Mp with a plurality of mail boxes to be shared by the voice-mail apparatuses 151-15m set thereto. The network storages NS1-NSp convert data coming from the LAN 2 into a file format possible to be processed by the plurality of voice-mail apparatuses 151-15m, and record it in an arbitrary mail box. The network storages NS1-NSp store programs and prompt data for reproducing the voice message stored in the arbitrary mail box in response to a reproduction instruction.

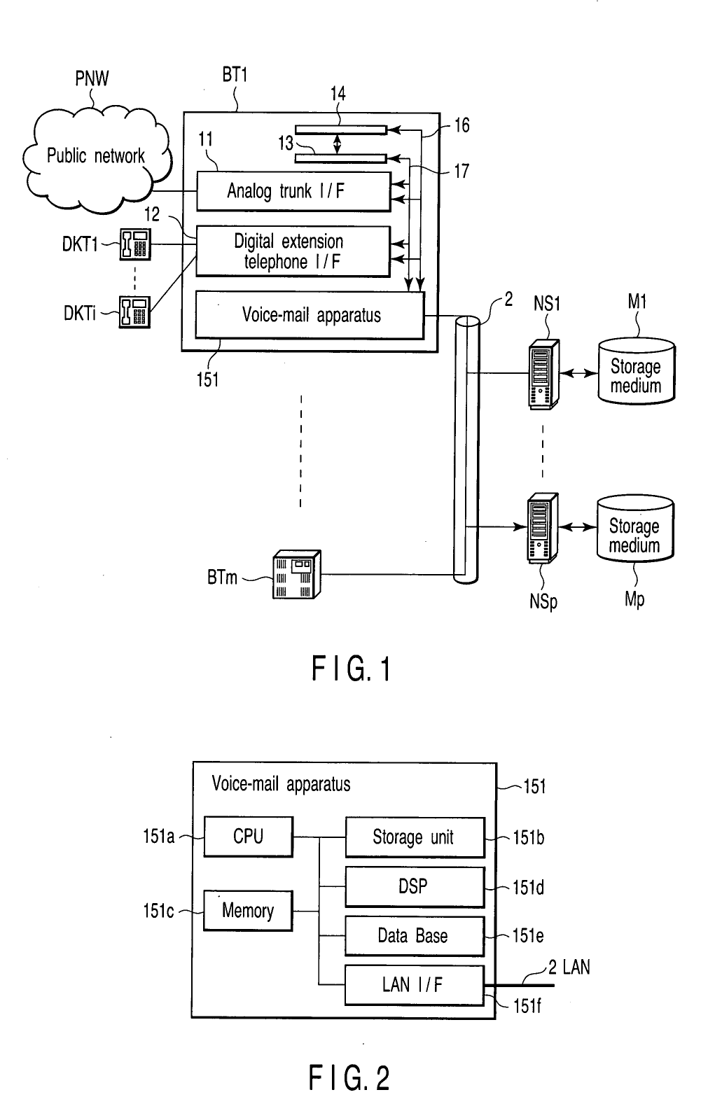

On the other hand, each plurality of voice-mail apparatuses 151-15m, as shown in FIG. 2, comprises a CPU 151a, a storage unit 151b, a memory 151c, a digital signal processor (DSP) 151d, a database 151e, and a LAN interface unit 151f. Here, the voice-mail apparatus 151 will be described as a representative thereof.

The storage unit 151b is provided with mail boxes corresponding to each extension terminal DKT1-DKTi. The program and the prompt data are stored in the memory 151c.

The DSP 151d controls the signal level of the voice message to be recorded or reproduced in or from the mail boxes of the storage unit 151b so that the signal level becomes a defined level.

The database 151e has stored condition information in which an order of access priority to the network storages NS1-NSp and an access procedure thereto in the case of an occurrence of a failure, etc., are described.

The LAN interface unit 151f performs interface processing to and from the LAN2.

The CPU 151a has an ordinal control function regarding a record reproduction of a voice message. The CPU 151a further has functions, as new functions regarding the invention, to transmit the voice message to the network storages NS1-NSp via the LAN2 and to record them in the mail boxes of the storage media M1-Mp corresponding to the extension terminal DKT1 to be the incoming call destination based on the condition information stored in the database 151e for requesting the record of the voice message, and to reproduce the voice message stored in the mail boxes in the storage media M1-Mp.

Operations of the system configured as mentioned above will be described below.

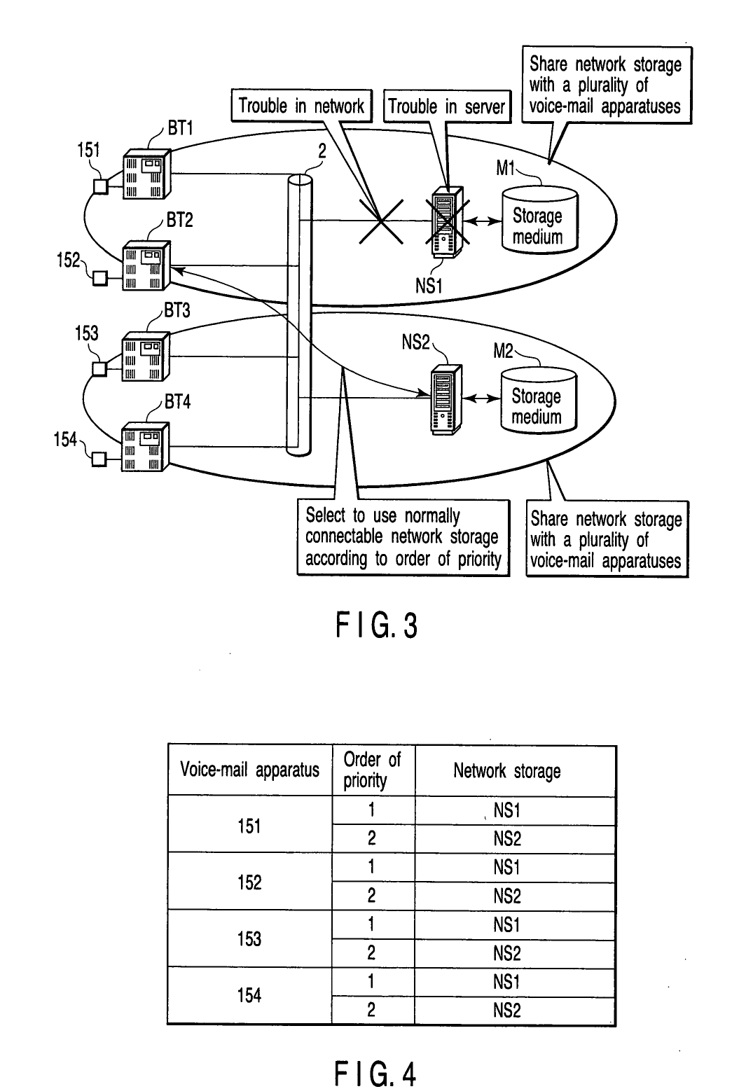

FIG. 3 illustrates a sequence view showing operations for connecting among the voice-mail apparatuses 151-15m and the network storages NS1-NSp. To make the description simple, the voice-mail apparatuses 151-154, and the network storages NS1-NS2 are described. Data, showing the correspondence relations among the voice-mail apparatuses 151-154, the order of access priority, and the network storages NS1, NS2 are stored in the database 151e as depicted in FIG. 4.

It is presumed that, for example, an incoming call arrives at the extension terminal of the main apparatus BT2 from the public network PNW, and that the incoming call is transferred to the voice-mail apparatus 152 because of absence of the user of the extension terminal or the like.

The CPU 152a then responds to the incoming call arrival, and reads out a guidance registered in the memory 152c, and passes the guidance to the caller.

When the caller conducts a recording operation to record a requirement in the voice-mail apparatus 152 in accordance with the guidance, the CPU 152a refers to the database 152e, and accesses to the network storage NS1 of which the order of access priority becomes “first”.

It is supposed that a trouble occurs in the network storage NS1 in this situation, and that the occurrence of the trouble results in a failure in access. The CPU 152a of the voice-mail apparatus 152 then refers to the database 152e to determine whether the next candidate is present or not. Here, the network storage NS2 is present as the next candidate. The CPU 152a of the voice-mail apparatus 152 accesses to the network storage NS2, and transfers a voice message to the network storage NS2. The CPU 152a then records the voice message in a specified mail box in a storage medium M2.

Thus, when a trouble occurs with the network storage NS1 or its communication path, the communication is automatically transferred to the network storage NS2 that is the next candidate. The caller then may leave the voice message on the storage medium M2 of the network storage NS2.

Reproducing the voice message is also performed in the same procedure as the recording procedure of the voice message.

As mentioned above, in the first embodiment, the communication system connects the plurality of network storages NS1-NSp to the plurality of voice-mail apparatuses 151-15m via the LAN 2 to share them, and shares the plurality of mail boxes of the storage media M1-Mp to be connected to the plurality of network storages NS1-NSp by means of the plurality of mail boxes which have been provided in each voice-mail apparatuses 151-15m. Based on the conditions, such as each trouble occurrence with the plurality of network storages NS1-NSp, and the order of access priority set thereto, the communication system selects an optimum network storage NS1. After this, the system executes voice message processing to the selected network storage NS1.

Accordingly, there is no need to connect external storage apparatuses for each voice-mail apparatuses 151-15m. Since the plurality of mail boxes of the storage media M1-Mp to be connected to the network storages NS1-NSp are also shared with the plurality of mail boxes which have been provided for each voice-mail apparatuses 151-15m, the system may enhance an effective use rate of a resource for sharing a small number of network storages NS1-NSp with voice-mail apparatuses 151-15m of which the number is larger than that of the network storages NS1-NSp. Therefore, the optimum network storages NS1-NSp can be selected in response to further various conditions.

As the program and prompt data to be stored in the storage media M1-Mp also being shared with the voice-mail apparatuses 151-15m, a general-purpose personal computer is available for the network storages NS1-NSp. In other words, the cost of the entire of the system may be reduced.

Also in the case in which a voice-mail apparatus is expected to be newly added, the system can respond the case only by expanding the memory capacities of the storage media M1-Mp to be connected to the network storages NS1-NSp, so that the whole of the system is excellent in expandability.

### SECOND EMBODIMENT

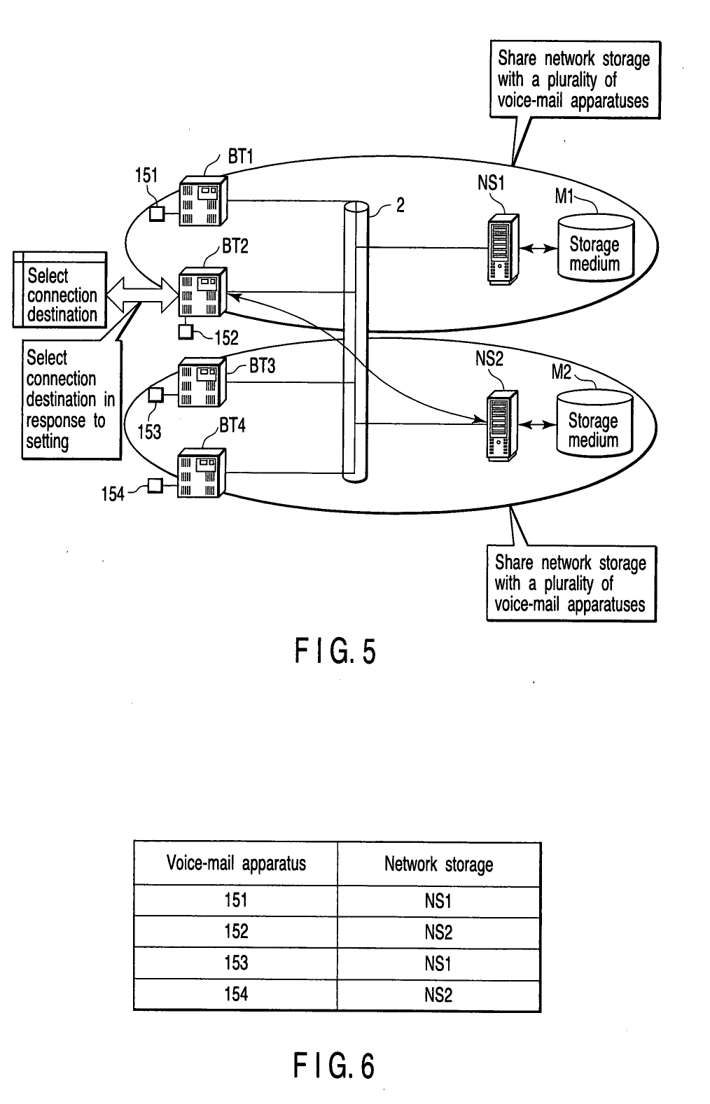

FIG. 5 is a sequence view showing operations for specifying the network storages NS1 and NS2 to be used for each voice-mail apparatuses 151-154 as the second embodiment. The database 151e, as shown in FIG. 6, has stored the data indicating the correspondence relation among the voice-mail apparatuses 151-154 and the network storages NS1, NS2.

For instance, it is presumed that an incoming call arrives at the extension terminal of the main apparatus BT2 from the public network PNW and that it is transferred to the voice-mail apparatus 152 because of absence of the user of the extension terminal or the like.

The voice-mail apparatus 152 then responds to the incoming call, passes its guidance to the caller. When the caller conducts a recording operation to record the requirement in the voice-mail apparatus 152 in accordance with the guidance, the CPU 152a of the voice-mail apparatus 152 refers to the database 152e, and accesses to the network storage NS2. The CPU 152a then transfers a voice message to the network storage NS2, and makes the specified mail box of the recording medium M2 record it.

In the meantime, it is presumed that an incoming call arrives at the extension terminal of the main apparatus BT1 from the public network PNW, and that it is transferred to the voice-mail apparatus 151 due to absence of the user of the extension terminal or the like. The voice-mail apparatus 151 then responds to the incoming call, and passes its guidance to the caller.

When the caller conducts a recording operation to record the requirement in the voice-mail apparatus 151 in accordance with the guidance, the CPU 151a of the voice-mail apparatus 151 refers to the database 151e, and accesses to the network storage NS1. The CPU 151a then transfers a voice message to the network storage NS1, and makes the specified mail box of the recording medium M1 record it.

As given above, in the second embodiment, the communication system specifies the network storages NS1 and NS2 to be used for each voice-mail apparatuses 151-154 to distribute loads. Thereby, the system may expect the improvement of its response. For example, when a plurality of departments or persons share one system, the system may limit the network storages NS1 and NS2 to be used for each department or person, thereby, it may definitize processing, etc., for each department or person.

The network storages NS1 and NS2 being fixedly prepared for each voice-mail apparatuses 151-154, even if the processing requests of the voice messages are made in the same time zone in the voice-mail apparatuses 151 and 152, the system becomes possible to perform the processing in parallel. Thereby, the system can efficiently carries out the processing of the voice messages to the network storages NS1 and NS2.

In the second embodiment, the system may associate the network storages NS1 and NS2 with each mail box.

### THIRD EMBODIMENT

The third embodiment of the invention is a system for distributing loads in the same way of the aforementioned second embodiment. Here, a network storage has a scheme to grasp a current load situation in accordance with a CPU use rate, etc., and when an access is made from a voice-mail apparatus, if it exceeds the processing ability of the network storage, it notifies the situation of overload to the main apparatus, and makes the main apparatus use another network storage.

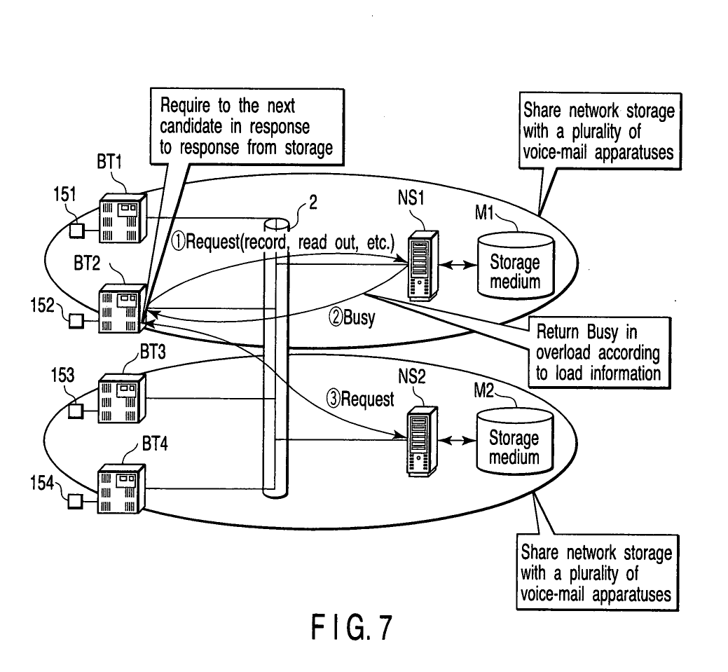

FIG. 7 depicts a sequence view showing operations in the case in which the communication system connects the voice-mail apparatuses 151-154 and the network storages NS1 and NS2 with one another as the third embodiment of the invention.

It is assumed that, for example, the extension terminal of the main apparatus BT2 receives an incoming call from the public network PNW, and the main apparatus BT2 transfers the incoming call to the voice-mail apparatus 152 due to the absence of the user of the extension terminal.

The voice-mail apparatus 152 then responds to the incoming call arrival, and sends its guidance to the caller. After the caller conducts a recording operation to record the requirement in the voice-mail apparatus 152 in accordance with the guidance, the CPU 152a of the voice mail apparatus 152 refers to the database 152e, and accesses to the network storage NS1 the order of access priority of which becomes “first”.

In such a state, the network storage NS1 monitors the processing load, namely the CPU sue rate, etc. If the load state exceeds a certain threshold, the network storage NS1 transmits a busy signal to the voice-mail apparatus 152 of a request origin.

As a result, the CPU 152a of the voice-mail apparatus 152 refers to the database 152e, and determines whether the next candidate is present or not. Here, the network storage NS2 is present as the next candidate. The CPU 152a accesses to the network storage NS2, and transfers the voice message to the network storage NS2 to record it in the specified mail box on the recording medium M2.

Thus, when the network storage NS1 is in overload, the communication at that time is automatically transferred to the network storage NS2 of the next candidate. The caller may leave the voice message on the storage medium M2 of the network storage NS2.

When reproducing the voice message, the system also may implement through the same procedure as the recording procedure of the voice message.

As mentioned above, according to the third embodiment, utilizing the busy response returned from the network storage NS1 enables the voice-mail apparatus 152 to be the request origin determine whether or not the CPU 152a can access to the selected network storage NS1. When it is determined that the CPU 152a of the voice-mail apparatus 152 cannot access to the network storage NS1, the CPU 152a accesses to the network storage NS2 and enables accurately recording the voice message.

### FOURTH EMBODIMENT

In the fourth embodiment, a communication system has a scheme to perform autonomous data synchronization among the network storages so that accessing of each voice-mail apparatus to any network storage does not pose any problem. As to the synchronization of the data, a method of controlling the synchronization by the voice-mail apparatus is a possible approach in addition to the case in which the network storages perform autonomous synchronization of the data.

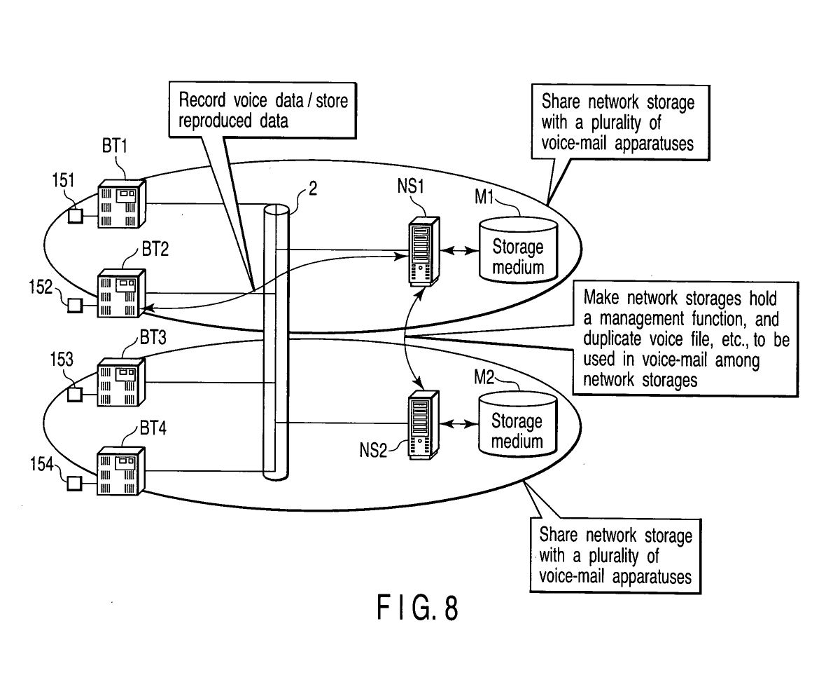

FIG. 8 shows a sequence view depicting operations for synchronizing the data between the network storages NS1 and NS2 as the fourth embodiment of the invention.

It is presumed that, for instance, an incoming call arrives at the extension terminal of the main apparatus BT2 from the public network PNW, and that the incoming call is transferred to the voice-mail apparatus 152 because of the absence of the user the extension terminal.

The voice-mail apparatus 152 then responds to the incoming call, and sends its guidance to the caller. When the caller conducts the recording operation so as to record the requirement in the voice-mail apparatus 152 in accordance with the guidance, the CPU 152a of the voice-mail apparatus 152 refers to the database 152e, and accesses to the network storage NS1. The CPU 152a transfers the voice message to the network storage NS1, and records it in the specified mail box of the storage medium M1.

In this status, the network storage NS2 monitors update of the voice message, the program, and the prompt data in the network storage NS1. In the case of implementation of update, the network storage NS2 obtains the voice message, program, and prompt data from the network storage NS1 to update the data on the storage medium M2.

As described above, according to the fourth embodiment, the network storage NS2 voluntarily obtains the voice message, program, prompt data, etc., from another network storage NS1, and determines the presence or absence of the update. If the voice message, program, prompt data, etc., are updated, the network storage NS2 records the updated voice message, program, prompt data, etc., onto the storage medium M2.

Therefore, the system may synchronize the data among the network storages quickly without having to conduct update processing through a manual operation by a maintenance person, and may improve the reliability of the whole of the system.

### FIFTH EMBODIMENT

In the fifth embodiment of the invention, the communication system uses an internal storage apparatus thereof to store a history and data therein when the voice-mail apparatus cannot use all network storages due to the troubles therewith, and when the network storages are recovered, the system reflects the corrected data.

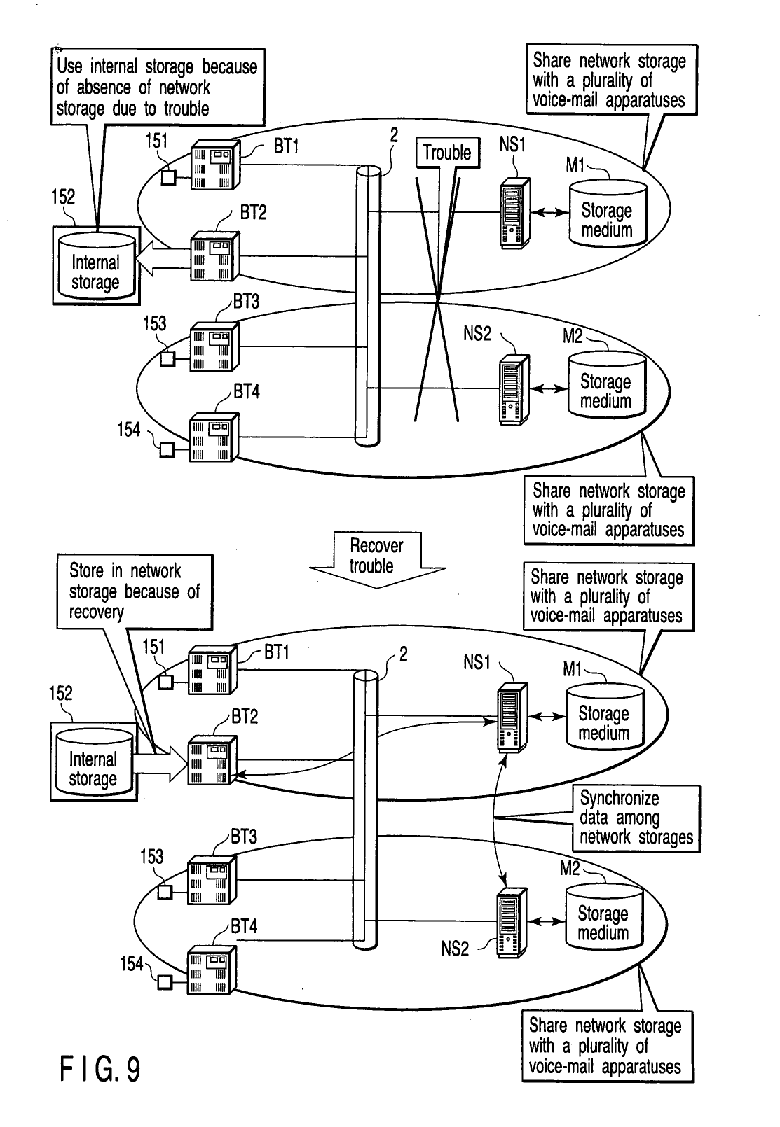

FIG. 9 illustrates a sequence view showing the case of occurrences of troubles in the network storages NS1 and NS2 as the fifth embodiment of the invention.

It is supposed that, for example, an incoming call arrives at the extension terminal of the main apparatus BT2 from the public network PNW, and that the incoming call is transferred to the voice-mail apparatus 152 because of the absence of the user of the extension terminal.

The voice-mail apparatus 152 then makes an incoming call response, and sends its guidance to the caller. When the caller performs the recording operation to record the requirement in the voice-mail apparatus 152, the CPU 152a of the voice-mail apparatus 152 refers to the database 152e, and makes access to the network storage NS1.

In such a situation, it is assumed that there is something wrong with the network storages NS1 and NS2, and the occurrences of the troubles pose failures in access. The CPU 152a of the voice-mail apparatus 152 records the voice message in the specified mail box of the storage unit 152b. At the same time, the CPU 152a stores the history of data change as well into the storage unit 152b.

Meanwhile, the voice-mail apparatus 152 monitors the trouble recovery of the network storages NS1 and NS2. After the network storages NS1 and NS2 are recovered from their troubles, the voice-mail apparatus 152 transfers the voice message stored in the storage unit 152b to the network storage NS1, and records it on the storage medium M1.

The network storage NS2 monitors the update of the voice message, of the program, of the prompt data, etc. After the update, the network storage NS2 acquires the voice message, program, and prompt data from the network storage NS1 to update the data in the storage medium M2.

As described above, according to the fifth embodiment, when all the plurality of network storages NS1 and NS2 become impossible to be accessed due to the occurrences of troubles, the communication system records the voice message into the storage unit 152b of the voice-mail apparatus 152 to be the request origin. The system thereby may prevent an omission of recording the voice message, and may provide a stable voice-mail service.

When the connection between the network storages NS1 and NS2 are recovered, the system automatically transfer the voice message, the updated program, and prompt data in the voice-mail apparatus 152 to the network storage NS1, and stores them in the storage medium M1. Therefore, for instance, when the troubles in the network storages NS1 and NS2 are fixed correctly, the system may quickly reflect the update of the voice message, program, and prompt data in the voice-mail apparatus 152 to the network storages NS1 and NS2 without having to wait recovery operations by the maintenance person.

### OTHER EMBODIMENT

The invention is not limited to the foregoing each embodiment. While the first embodiment has been described in an example which uses the trouble occurrences in the network storages and the order of access priority to the network storages as conditions to use for access to the plurality of network storages, the invention is not limited by the first embodiment, and a traffic situation of a LAN, previous communication quality, etc., may be available. In the case of the use of the previous communication quality, the voice-mail apparatus may have a function to measure communication quality information in communicating with network storages.

Having described an example to select a single network storage in each embodiment given above, it is obvious that the invention is possible to simultaneously select a plurality of network storages and access them.

While each of the aforementioned embodiments has described in an example which carries out the recording processing of the voice massage to the network storage by means of the CPU in the voice-mail apparatus, it is to be understood that a central processing unit of a main apparatus and an external control unit may carry out the recording processing.

In addition to these, as for the configuration and type of the system, the configuration and type of the main apparatus, the kind of the extension terminal, the recording or reproduction control procedure and control content of the voice message, etc., various modifications may be made without departing from the scope and spirit of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as world fall within the scope and spirit of the inventions.

What is claimed is:

1. A communication system, comprising:
a plurality of voice-mail apparatuses which record a voice message transmitted from a telephone terminal in an arbitrary mail box among a plurality of mail boxes, and reproduces the voice message recorded in the arbitrary mail box in response to a reproduction instruction;
a plurality of memory apparatuses which include a plurality of mail boxes connected to the plurality of voice-mail apparatuses via a data transmission path and shared among the plurality of voice-mail apparatuses, convert the voice message incoming from the data transmission path into a file format possible to be processed by the plurality of voice-mail apparatuses to record it in the arbitrary mail box, and store control programs and control data necessary to reproduce the voice message recorded in the arbitrary mail box in response to the reproduction instruction; and
a controller which selects at least one of memory apparatuses among from the plurality of the memory apparatuses, and executes processing of the voice message for the selected memory apparatus based on prescribed conditions, when processing requests of the voice message transmitted from a telephone terminal are made.

2. The communication system according to claim 1, wherein the controller uses at least one of each load situation of the plurality of memory apparatuses, each trouble occurrence of the plurality of memory apparatuses, a load situation of the data transmission path, previous communication quality, and order of access priority for the plurality of memory apparatuses, to determines the conditions.

3. The communication system according to claim 2, wherein the controller includes a function to measure communication quality information in communicating with the memory apparatuses.

4. The communication system according to claim 1, wherein the controller uses either contents prescribed for each of the plurality of voice-mail apparatuses or contents prescribed for each of the plurality of mail boxes, to determine the conditions.

5. The communication system according to claim 1, wherein
the plurality of memory apparatuses include means for returning a busy response in the case of load states more than a reference value, and
the controller selects a memory apparatus to be a minimum load based on a return result of the busy response.

6. The communication system according to claim 1, wherein the controller executes the processing of the voice message to the email box in the voice-mail apparatus corresponding to the telephone terminal of the request origin, when all the plurality of memory apparatuses are impossible to be accessed due to trouble occurrences.

7. The communication system according to claim 6, wherein the controller monitors recovery situations of the memory apparatus, and when the memory apparatus is recovered, transfers the control program and the control data recorded in the corresponding voice-mail apparatus and the voice message recorded in the mail box to the memory apparatus, and records the control program, the control data and the voice message in the memory apparatus.

8. The communication system according to claim 1, wherein each of the plurality of memory apparatuses acquires the voice message, the control program, and the control data recorded in other plurality of memory apparatuses, respectively, and determines presence or absence of update, and when the voice message, the control program, and the control data are updated, each of the plurality of memory apparatuses records the updated voice message, control program, and control data.

9. A voice message processing method for use in a communication system provided with a plurality of voice-mail apparatuses, comprising:
recording a voice message transmitted from a telephone terminal in an arbitrary mail box among a plurality of mail boxes;
reproducing the voice message recorded in the arbitrary mail box in response to a reproduction instruction;
connecting a plurality of memory apparatuses to the plurality of voice-mail apparatuses via a data transmission path, wherein each of the plurality of memory apparatuses includes a plurality of mail boxes to be shared to the plurality of voice-mail apparatuses;
converting the voice message arrives from the data transmission path into a file format possible to be processed by the plurality of voice-mail apparatuses to record it in the arbitrary mail box;
storing control program and control data to reproduce the voice message recorded in the arbitrary mail box in response to the reproduction instruction;
selecting at least one of memory apparatuses among from the plurality of memory apparatuses based on prescribed conditions, when a processing request for the voice message is made from the telephone terminal; and
carrying out processing of the voice message for the selected memory apparatus.
